(19) United States
(12) Patent Application Publication
(10) Pub. No.: US 2007/0108710 A1
(43) Pub. Date: May 17, 2007

(54) Child stroller construction

(76) Inventors: Ricky C. Pennisi, North Caldwell, NJ (US); Frank Pennisi, Howell, NJ (US)

Correspondence Address: KLAUBER & JACKSON, 411 HACKENSACK AVENUE, HACKENSACK, NJ, 07601, US

(21) Appl. No.: 11/519,239

(22) Filed: Sep. 11, 2006

Related U.S. Application Data
(60) Provisional application No. 60/717,472, filed on Sep. 15, 2005.

(51) Int. Cl. B62B 7/00

(52) U.S. Cl. 280/47.38

(57) ABSTRACT

A child stroller is provided which obviates the shortcomings of the prior art by providing a safe and effective positioning site for an auxiliary seat, which seat is so positioned at the upper reaches of the stroller handle as to place the child in close interacting proximity to the parent or other caregiver. The optionally removable seat is reversible so that the child may face either forward or rearward. An extended wheelbase protects the stroller against instability and tipping when the seat is emplaced at the handle.

This application claims priority from U.S. Provisional Applications Ser. No. 60/717,472, filed Sep. 15, 2005.

### FIELD OF INVENTION

This invention relates generally to child stroller constructions, and more specifically relates to a stroller which is provided with an auxiliary seat optionally removable and reversibly mounted at the stroller steering handle.

### BACKGROUND OF THE INVENTION

Child and baby strollers are most commonly designed with a seat secured at the base chassis, and with an extended pushing and steering handle sloping upwardly to the rear of the stroller to permit a parent or other caregiver to wheel the stroller about. One of the disadvantages of this conventional arrangement is that the young child is at a considerable and inconvenient distance from the parent or other caregiver who is pushing the stroller. This renders it difficult for the caregiver to readily interact with the child and to observe the child's condition and/or needs as the stroller is wheeled about. This is further complicated by the usual arrangement wherein the seated child faces forward at the relatively distant position.

It would be desirable for the reasons aforementioned if the child could optionally be in closer and more comfortable proximity to the caregiver. It may be noted in this connection that the prior art has taught the concept of a removable auxiliary seat which in some of these prior art arrangements is positioned above and to the rear of the main chassis mounted seat. In most instances such auxiliary seat has as its primary object to provide a second seat for use by an additional child, but an incidental advantage is that the second seat is indeed closer to the operating parent or other caregiver. In a few of these instances the auxiliary seat has even been secured at a portion of the steering handle. However these prior arrangements have generally been unsatisfactory from various viewpoints, including that in many arrangements the position of the auxiliary seat is such as to shift the center of gravity of the stroller as to introduce dangerous instability, thereby creating the possibility of tipping. Furthermore in many of these prior art instances the placement of the auxiliary seat still leaves the child considerably spaced from the parent or other caregiver, and also places the child in a forward facing position which limits interaction with the caregiver.

### SUMMARY OF INVENTION

Now in accordance with the present invention a stroller is provided which obviates the shortcomings of the prior art and otherwise provides a safe and effective auxiliary seat, which is so positioned at the upper reaches of the stroller handle as to place the child in close interacting proximity to the operator.

The stroller includes a main frame having a pushing handle defined by upwardly sloping side rails terminating with and adjoining a hand graspable cross piece. A set of front wheels is secured to the frame at the front of its base chassis and a set of rear wheels is rotably mounted at the rear of the chassis. A seat positioning site is secured across the side rails at a position closely spaced from the hand graspable cross piece. The seat positioning site is adapted to securely, and optionally removably, hold an auxiliary seat so that a child positioned in such seat is in close proximity to the caregiver. The position of the seat is such that the center of gravity of a child positioned upon the seat is forward of the axes of rotation of the rear wheels to assure stability for the stroller.

### BRIEF DESCRIPTION OF DRAWINGS

The invention is diagrammatically illustrated by way of example in the drawings appended hereto in which:

FIG. 1 is a perspective view of a stroller incorporating the present invention taken from the right front side;

FIG. 2 is a right side view of the stroller in FIG. 1;

FIG. 3 is a view similar to FIG. 1 but showing the auxiliary seat affixed in a rearward rather than a frontward facing direction;

FIG. 4 is a right side view of the stroller arrangement of FIG. 3;

FIG. 5 is a rear perspective view of the handle portion of the stroller with the mounting platform for the stroller shown in a folded position;

FIG. 6 is a right side view of the stroller, showing again the folded platform arrangement in FIG. 5;

FIG. 7 is a perspective view looking rearward at the folded platform of FIGS. 5 and 6;

FIG. 8 is a perspective view from the right front of the stroller showing the platform for the seat in its opened position at the positioning site;

FIG. 9 is a view similar to FIG. 8, but in enlarged fashion;

FIG. 10 is a right rear perspective view showing the opened platform affixed to the handle;

FIG. 11 is a right front perspective view showing the open platform of FIG. 10;

FIG. 12 is a right rear perspective view of the stroller of the invention, showing a folded child seat engaged with the platform at the positioning site;

FIG. 13 is a view similar to FIG. 12 but showing the same arrangement from a right front perspective position;

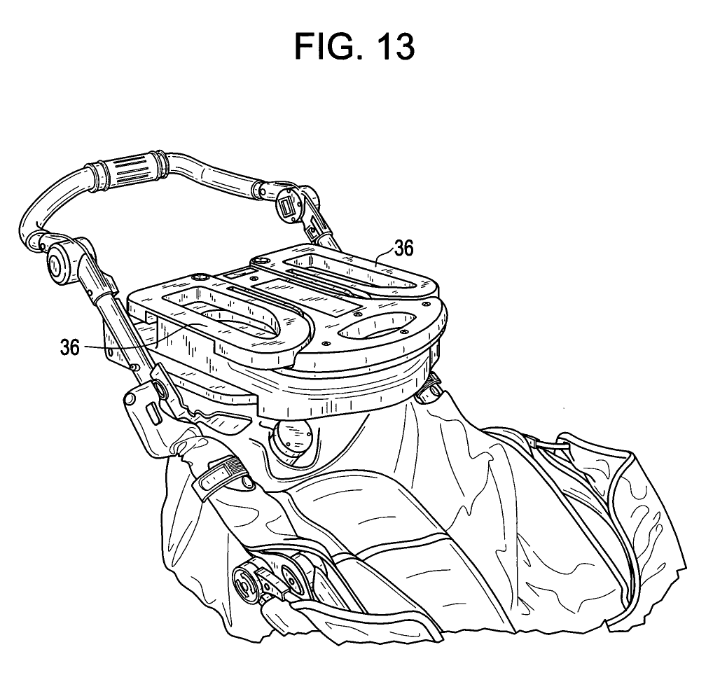

FIG. 14 is a right rear perspective view showing the stroller in its folded position for storage or carrying and illustrating where the auxiliary seat components and platform are placed and affixed; and

FIG. 15 is a perspective view of the underside of the seat base, showing the mechanism for securing the seat at the positioning site where the seat is of the optionally removable type.

### DESCRIPTION OF PREFERRED EMBODIMENT

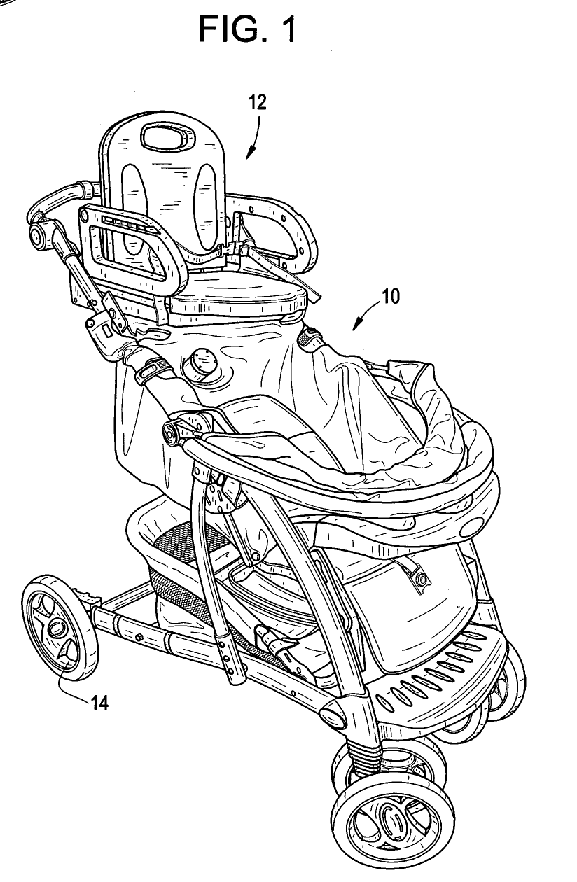

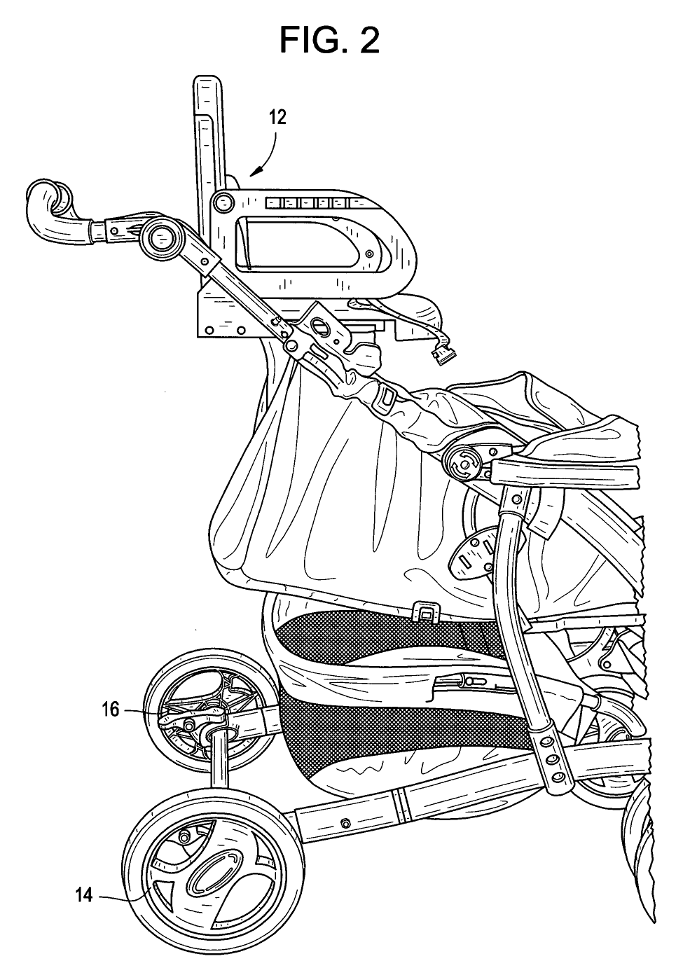

In the drawings appended hereto, and referring first to FIG. 1, a right front perspective view appears of a stroller 10 incorporating the features of the invention. The stroller 10 with respect to the portions of same below the auxiliary seat assembly 12 is generally conventional, except for one significant distinction from the prior art. Specifically, and as will be discussed further below, the wheel base of the stroller has been extended by rearward displacement of the rear wheels 14 and 16 of the order of 6 or more inches from their conventional position. This is important, as will be seen for example from FIG. 2 which shows with respect to seat assembly 12 that the wheels 14 and 16, and specifically their axes of rotation, are clearly rearward of the center of gravity of a child placed in the seat 18.

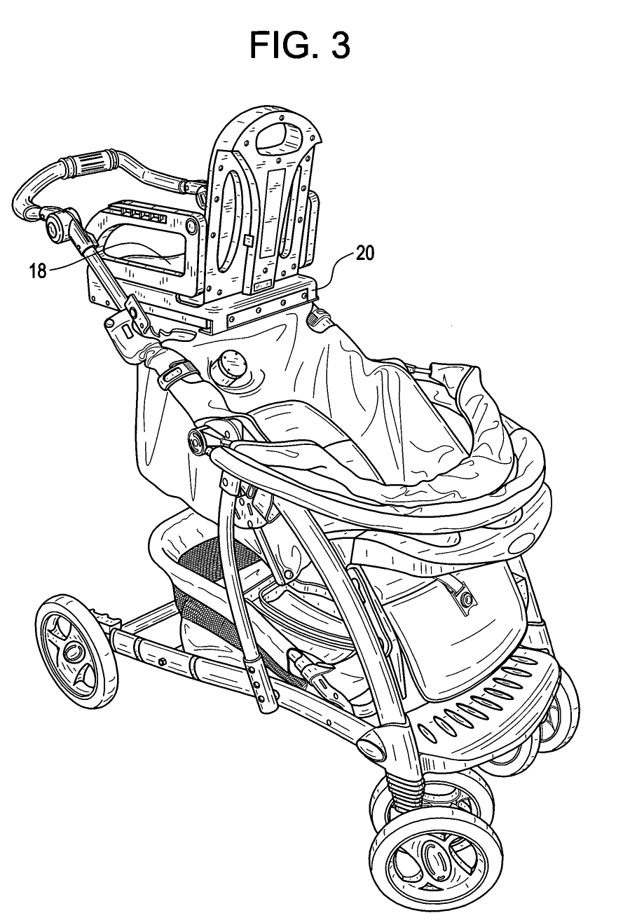

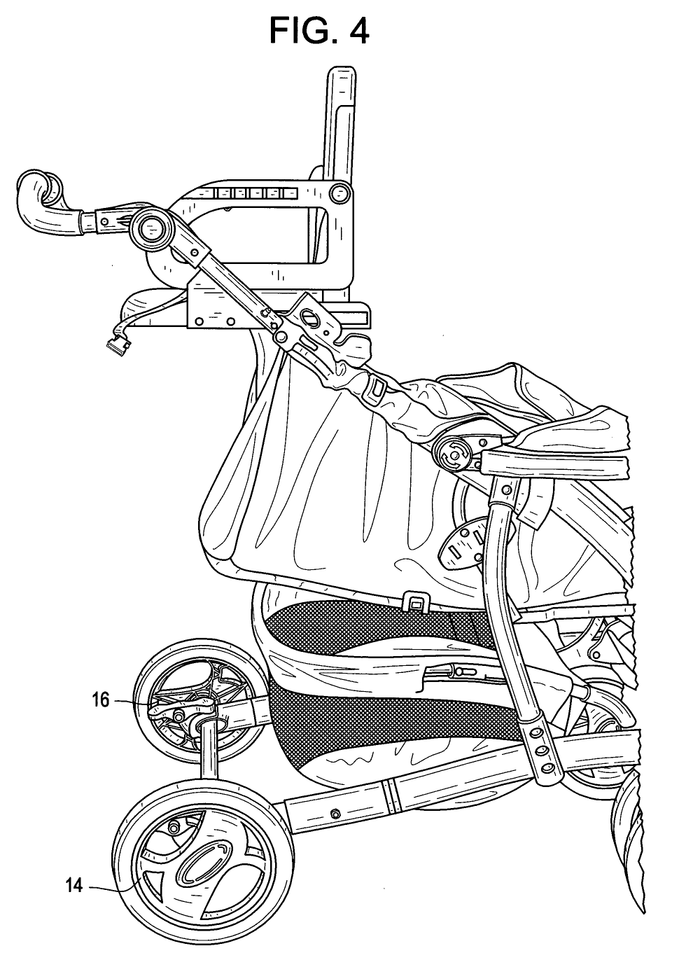

The seat 18 is provided with a base 20 which is securable to a platform generally indicated at 22. It will be seen from FIGS. 2 and 3 that the seat 18 and base 20 which are preferably removably affixed to platform 22 can be reversed in position, i.e. in FIG. 3 the child's seat faces rearward whereas in FIG. 2 it faces in a forward direction. FIG. 4 shows a further side view of the seat assembly 12 when the seat 18 is positioned facing rearwardly.

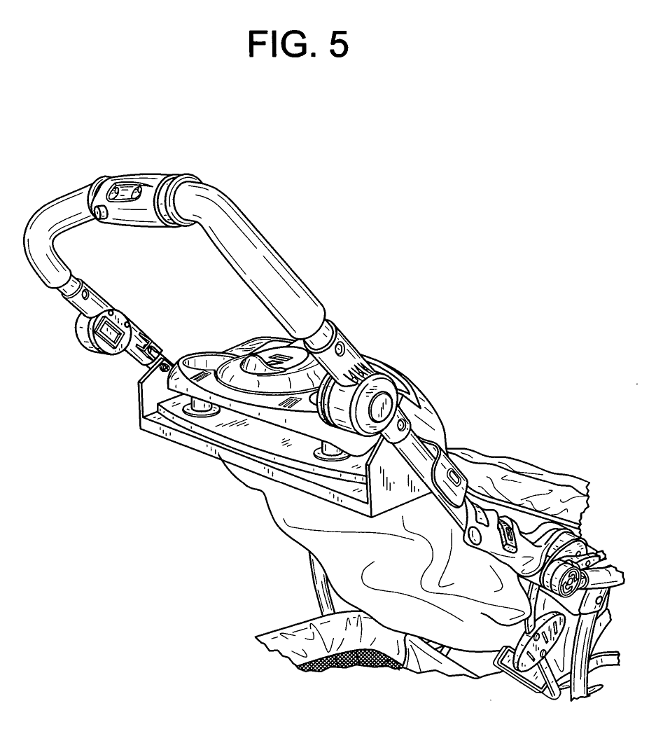

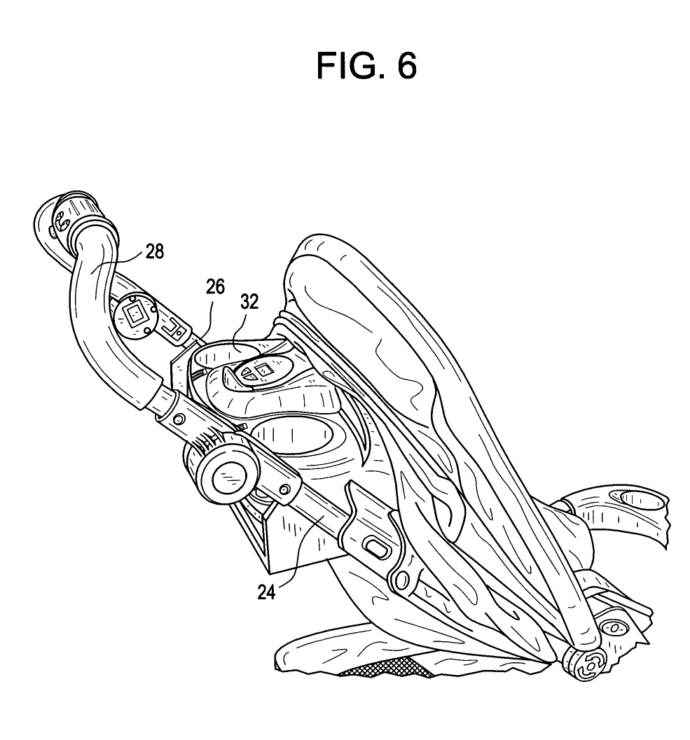

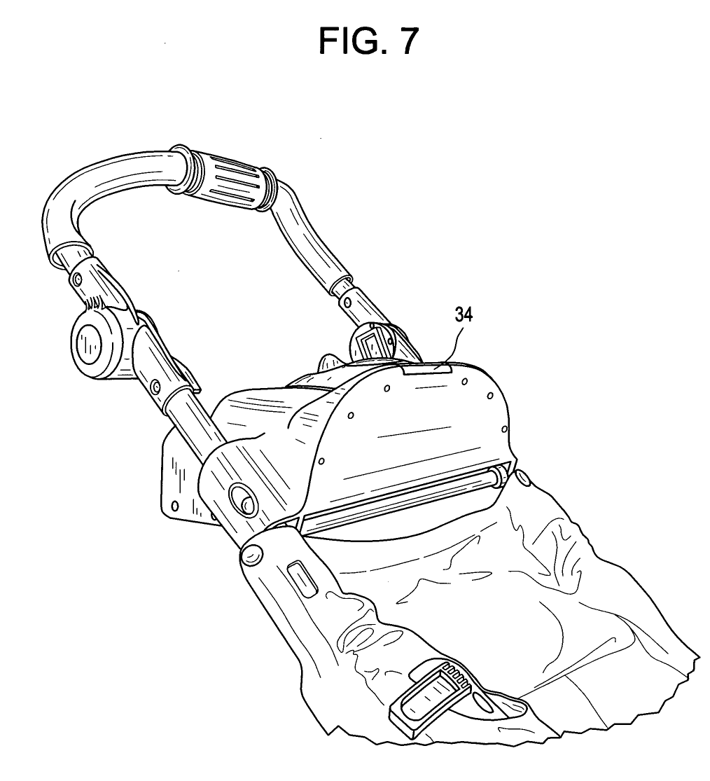

In FIGS. 5, 6 and 7 the platform 22 for the seat 18 is seen to be affixed to the side rails 24 and 26 at a position close to the graspable cross piece 28. The platform 22 in FIGS. 5, 6 and 7 is shown in a folded position, which would correspond, to use of the present stroller without the optionally removable auxiliary seat being attached. It is noted that in this closed, folded position the upwardly facing portion 30 of the folded device includes conventional features that are found in the stroller of the present type, such as cup holding portions 32 and the like. These are not per se aspects of the invention. When folded, it is noted too from FIG. 7 that a filler piece 34 is provided to enclose the folded device.

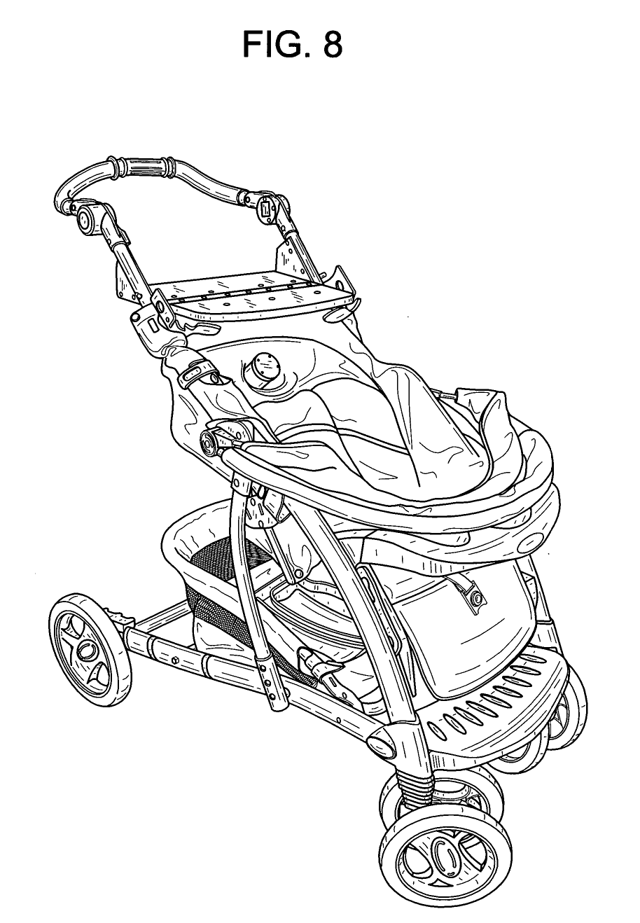

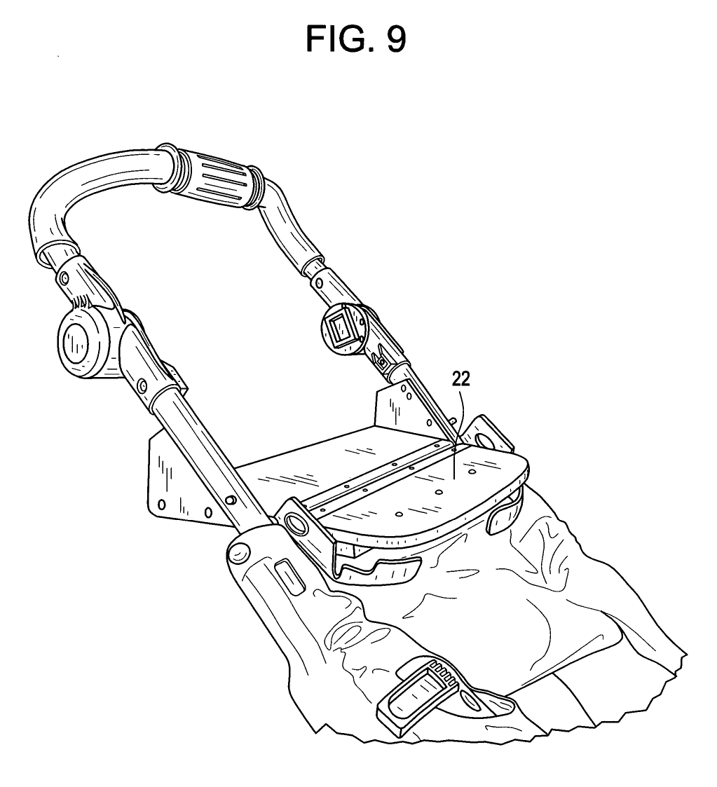

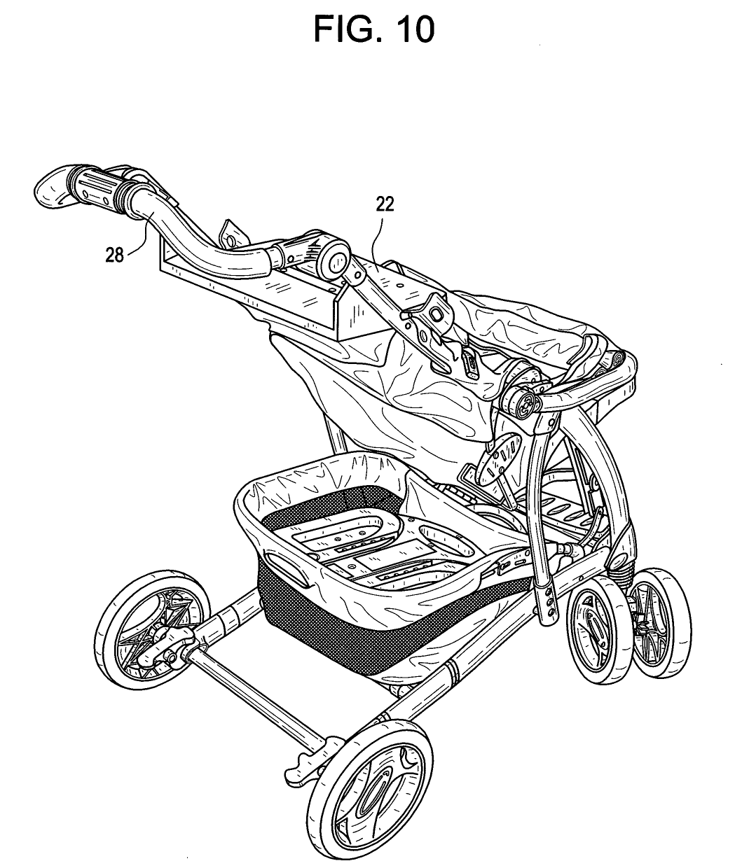

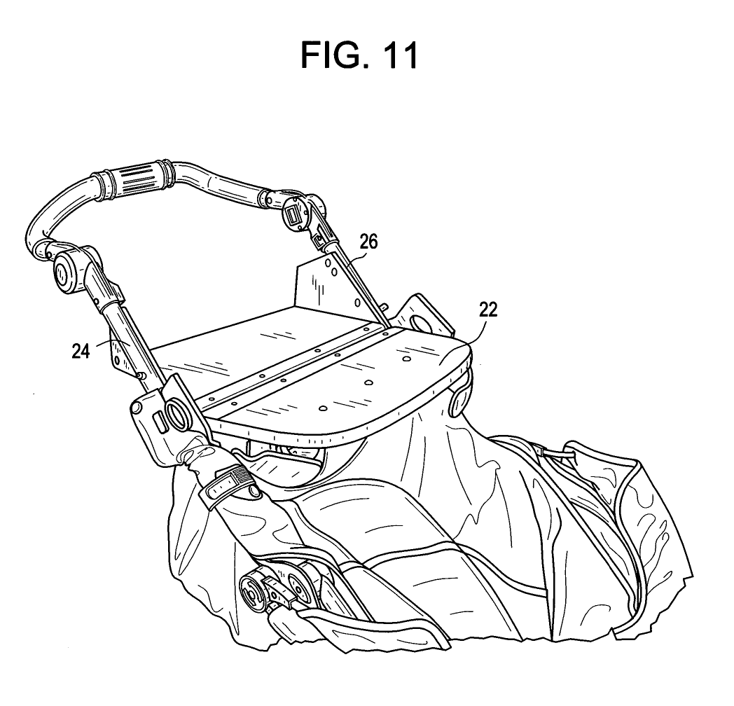

FIGS. 8, 9, 10 and 11 are further views showing the platform 22 in its open position ready to receive the seat to be mounted.

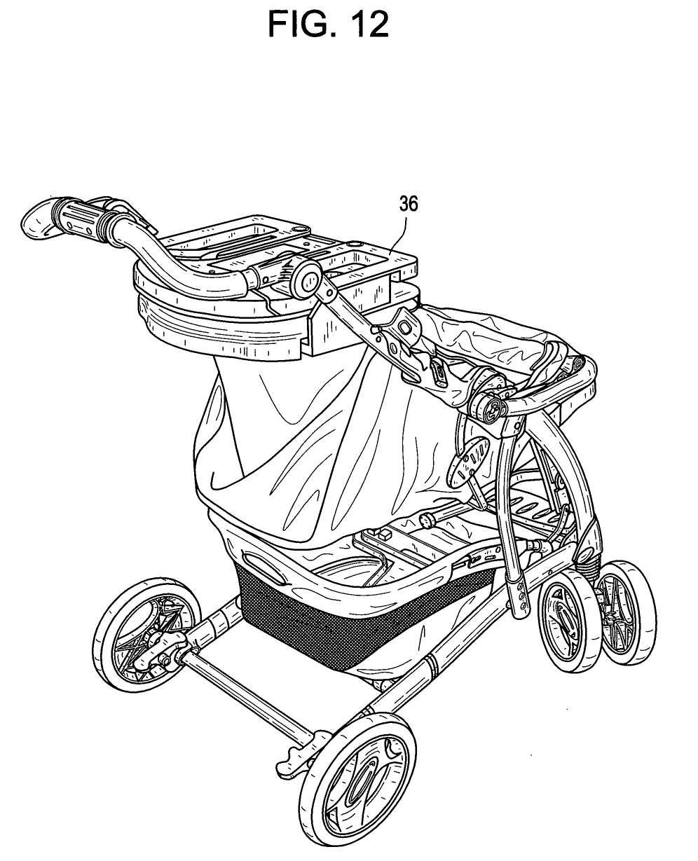

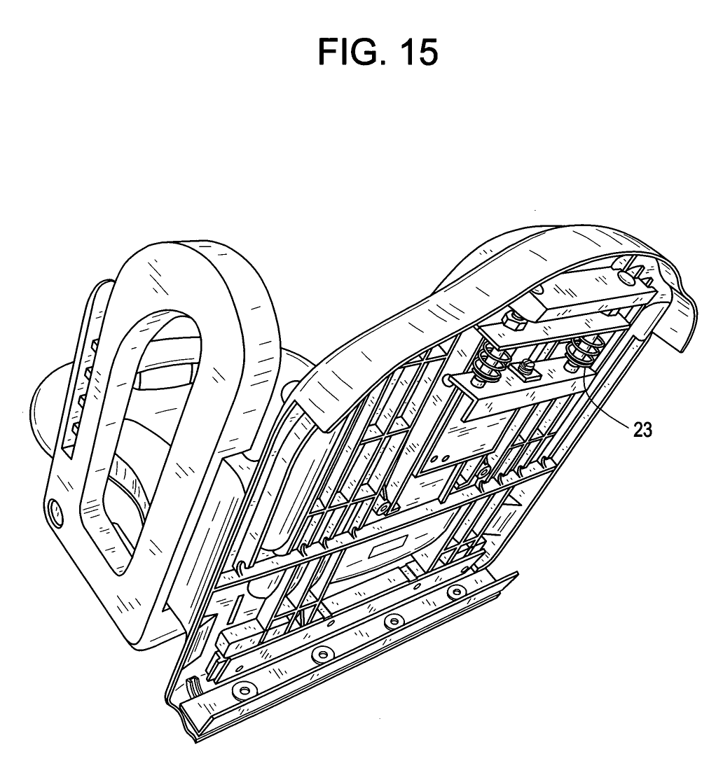

In the view of FIG. 12 the base 20 holding the folded seat 18 (with its side arms 36 folded) is seen to be affixed to the open platform 22. In FIG. 15 where the seat is of the optionally removable type, a simple spring mechanism 23 can be used for this purpose, or other convenient holding means can be employed.

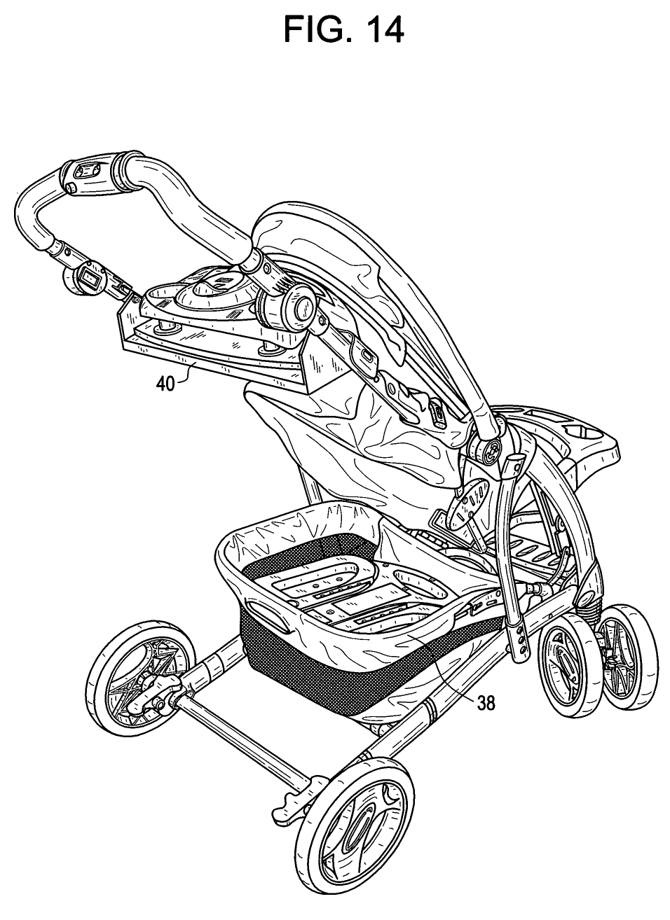

FIG. 14 shows the entire stroller in a folded position which is the position normally used for storage or transport as, for example, in an automobile or SUV. To be noted here is that the removable seat now sits in a lower storage bin 38 and that the platform at the seat positioning site is in the folded position, as shown at 40.

While the present invention has been set forth in terms of specific embodiments thereof, it will be clear to those skilled in the art that numerous variations upon the invention are not enabled which variations yet reside within the scope of the invention. Accordingly, the invention is to be broadly construed and limited only by the scope and spirit of the disclosure and accompanying claims.

1. A stroller comprising:
a main frame including a base chassis and a pushing handle extending from said chassis and defined by upwardly sloping side rails terminating at an adjoining hand graspable cross piece;
a set of front wheels rotably mounted to the chassis at the front thereof;
a set of rear wheels rotably mounted to said chassis at the rear thereof;
a child seat, which optionably is removable;
a positioning site means for said child seat secured between said side rails at a position closely spaced from said hand graspable cross piece, said site means being adapted to securely and hold said child seat, whereby a child seated thereat is in close proximity to a caregiver pushing the stroller;
and wherein the position of said child seat when secured at said positioning site means is such that the center of gravity of a child positioned on said seat is forward of the rotational axes of said rear wheels to insure stability for the stroller.

2. A stroller in accordance with claim 1, wherein the child seat is removable from said site means.

3. A stroller in accordance with claim 1, wherein said child seat is fixed at said site means.

4. A stroller in accordance with claim 2 wherein the positioning site means for the seat comprises a foldable platform affixed at each side to the said side rails of said stroller.

5. A stroller in accordance with claim 4, wherein the said child seat is provided with a base and means for securing the base and thereby the seat to the said platform.

6. A stroller in accordance with claim 5 wherein the said child seat can be positioned and secured to said platform in either a frontward or rearward facing position.

7. A stroller in accordance with claim 6, wherein the said platform at the positioning site is foldable on an axis transverse to the stroller direction of movement when the said seat is not affixed thereto, and wherein when folded the upwardly facing side is provided with receiving spaces for cups and other items.
